(19) United States
(12) Patent Application Publication
(10) Pub. No.: US 2007/0198482 A1
(43) Pub. Date: Aug. 23, 2007

(54) Dynamic data formatting during transmittal of generalized byte strings, such as XML or large objects, across a network

(75) Inventors: Terry Dennis Allen, San Jose, CA (US); Toby James William Haynes, Richmond Hill (CA); Kelvin Ho, Richmond Hill (CA); James Willis Pickel, Gilroy, CA (US); Michael Ronald Springgay, Toronto (CA); Frankie K. Sun, North York (CA); Maryela Evelin Weihrauch, San Jose, CA (US)

Correspondence Address: SANDRA M. PARKER;LAW OFFICE OF SANDRA M. PARKER, 329 LA JOLLA AVENUE, LONG BEACH, CA, 90803, US

(73) Assignee: International Business Machines Corporation, Armonk, NY (US)

(21) Appl. No.: 11/358,467

(22) Filed: Feb. 21, 2006

(51) Int. Cl. G06F 17/30

(52) U.S. Cl. 707/3

(57) ABSTRACT

A method, apparatus and program storage device is provided for dynamic data formatting during transmittal of generalized byte string data across a computer network. Remote server dynamically changes format of each column string data value from the result set separately, according to actual size of the string data value, and returns it to a client. Small-size data value is returned in a single network return message as varchar type, in-line with the rest of the query data. Medium-sized data value is retrieved without locators and streamed in multiple return network messages in a separate data object following the query data and in the same response. Large-size data value is retrieved using locators and returned as a progressive reference in pieces of specified size, where each piece of data value is separately transferred under client's control when needed, thus eliminating the need to buffer large amount of data.

### BACKGROUND OF THE INVENTION

1. Field of the Invention

The present invention generally relates to database management systems, and, more particularly, to mechanisms within computer-based database management systems for dynamic data formatting during transmittal of generalized byte strings, like XML and LOB data, across a network.

2. Description of Related Art

The increasing popularity of electronic commerce has prompted many companies to turn to application servers to deploy and manage their applications effectively. Quite commonly, these application servers are configured to interface with a database management system (DBMS) for storage and retrieval of data. This often means that new applications must work with distributed data environments. As a result, application developers frequently find that they have little or no control over which DBMS product is to be used to support their applications or how the database is to be designed. In many cases, developers find out that data critical to their application is spread across multiple DBMSs developed by different software vendors.

Research has shown that it has become very popular in today's applications to use database columns, declared as supporting large object (LOB) data type, to store any character string data, regardless of their size, such as small character strings, serialized Java objects and XML documents. Usually, the actual declared size of these columns tends to be greater than that of a long varchar but much less than the maximum size that can be declared for a LOB data type, e.g., 2 GB, whereas the actual data value is much smaller than the declared column size. In those cases the LOB data type is being chosen instead of varchar or long varchar data type because it provides the capacity for the data value to grow. Because the LOB data type format was originally designed to store large amount of data its data retrieval was optimized for that purpose. Due to the popularity of the LOB data type usage, a demand has evolved for more efficient processing for small, medium and large data values stored in the LOB data type format.

One presently available solution for this problem, when an application developer uses LOB data type format for storing data, involves the approach that physically consolidates all data values, where the data may be from different data sources, into a single network message block, which will then be transferred. Another approach streams all potentially large data values separately. Currently, the interfaces, such as Java DataBase Connectivity (JDBC), effectively use locators to retrieve data in LOB data format regardless of whether the streaming mode is requested by the application. However, when the entire LOB data value is desired, using locators incurs unnecessary network flows, including having one network flow up front to request the length of the entire LOB data value so that the client can determine the proper offset and length for the SQL SUBSTR statements to avoid any unnecessary blank padding for the LOB data value.

In the DBMS data transfers, a LOB data value transfer is desirable when the LOB data has small value, whereas use of a locator is more practical for large LOB data value transfers as there is no need to materialize all the data at once. However, picking either approach for all LOB type columns in the result set is very inefficient. Thus, the developer is forced to turn to more complex and potentially cumbersome alternatives to gain access to needed data records. Often, the alternatives are more costly and time-consuming to implement, require a more sophisticated set of programming skills to implement DBMS technology, may consume additional machine resources to execute, may increase labor requirements for development and testing and potentially inhibit portability of the data itself

Currently, the locator is used with the SQL SLBSTR function to get a piece of the LOB value (Clob): VALUES( SUBSTR(:iClobLocator, :iFrom, :iLength)) INTO :szClob:syndicator.

However, this method produces numerous problems. Because the SUBSTR function will blank pad the return value if the actual LOB data is shorter than the requested length, the client has to determine the actual length up front and never ask for more than the actual length of the Clob to avoid the blank padding, which represents additional network flow to the server that can be spared. Moreover, when the client system asks for a particular piece size, it does not know if there is a partial character in the last few bytes of the piece until it converts the data from the source codepage to the target codepage. Thus, the client has to account for these unconvertable bytes when it sets the start position for the next piece. Further, locators remain active for an amount of time longer than necessary, consuming valuable server resources and possibly reaching the limit on the total number of active locators.

Therefore, there is a need to provide a method and a system which can dynamically change the character string data value format, during transmittal of generalized byte strings across a network, for efficient retrieval of all ranges of data values defined in XML format, LOB format and all datatypes that have the pattern of the column definition being much bigger than the actual size, thus optimizing data storage utilization and network efficiency.

### SUMMARY OF THE INVENTION

The foregoing and other objects, features, and advantages of the present invention will be apparent from the following detailed description of the preferred embodiments which makes reference to several drawing figures.

One preferred embodiment of the present invention is a method for dynamic data formatting during transmittal of generalized byte string data across a computer network. Remote server dynamically changes format of each column string data value from the result set separately, according to actual size of the string data value, and returns it to a client. Small-size data value is returned in a single network return message as varchar type, in-line with the rest of the query data. Medium-sized data value is retrieved without locators and streamed in multiple return network messages in a separate data object following the query data and in the same response. Large-size data value is retrieved using locators and returned as a progressive reference in pieces of specified size, where each piece of data value is separately transferred under client's control when needed, thus eliminating the need to buffer large amount of data.

Another preferred embodiment of the present invention is a system implementing the above-mentioned method embodiment of the present invention.

Yet another preferred embodiment of the present invention includes a program storage device tangibly embodying a program of instructions executable by the computer to perform method steps of the above-mentioned method embodiment of the present invention.

### BRIEF DESCRIPTION OF THE DRAWINGS

Referring now to the drawings in which like reference numbers represent corresponding parts throughout:

FIG. 1 illustrates a block diagram of an exemplary computer hardware and software environment, according to the preferred embodiments of the present invention; and

FIG. 2 illustrates a flowchart of an exemplary method for dynamic data formatting, according to the preferred embodiments of the present invention.

### DETAILED DESCRIPTION OF THE PREFERRED EMBODIMENTS

In the following description of the preferred embodiments reference is made to the accompanying drawings which form the part thereof, and in which are shown by way of illustration specific embodiments in which the invention may be practiced. It is to be understood that other embodiments may be utilized, and structural and functional changes may be made without departing from the scope of the present invention.

The present invention is directed to a system, method and program storage device embodying a program of instructions executable by a computer to perform the method of the present invention for dynamic data formatting during transmittal of generalized byte string data, such as large object (LOB), XML data, and all datatypes that have the pattern of the column definition being much bigger than the actual size, across a network, where the data may reside in multiple data sources and are possibly stored in different formats. The method can dynamically change the character string data value format and efficiently retrieve all ranges of data values defined in XML or LOB format and all datatypes that have the pattern of the column definition being much bigger than the actual size, by controlling a data value return mode according to the actual data value size, thus optimizing data storage utilization and network efficiency.

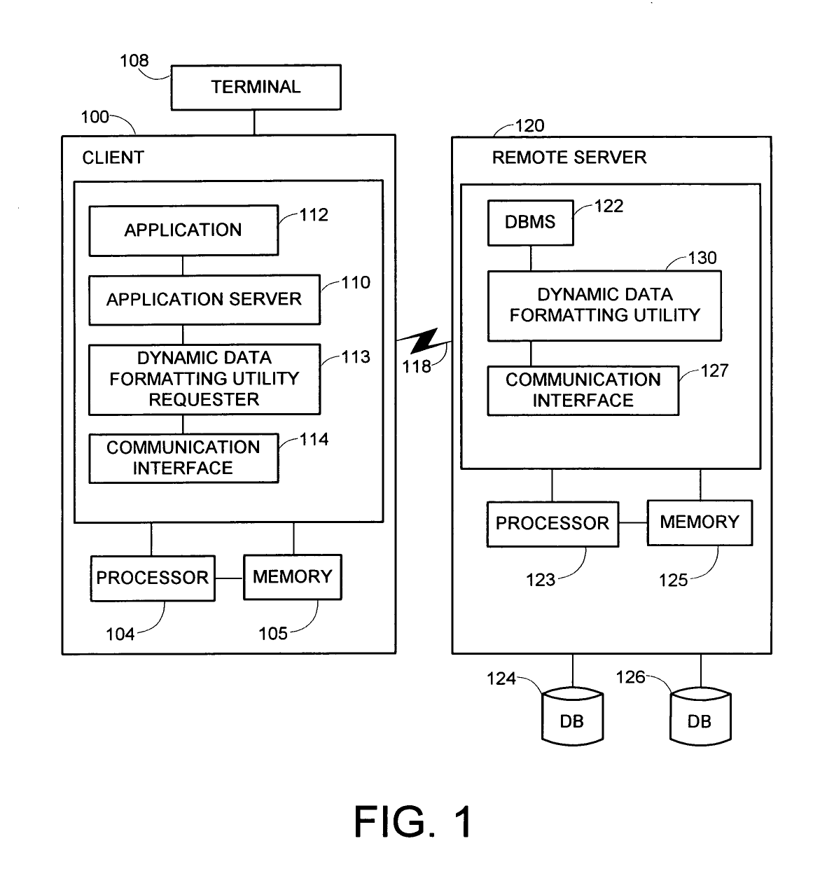

FIG. 1 illustrates an exemplary computer hardware and software environment usable by the preferred embodiments of the present invention to enable the dynamic data formatting method of the present invention. FIG. 1 includes a client 100 having a client terminal 108 and one or more conventional processors 104 executing instructions stored in an associated computer memory 105. The memory 105 can be loaded with instructions received through an optional storage drive or through an interface with a computer network. Client 100 further includes an application software server 110 capable of interfacing with an application 112 and a dynamic data formatting utility requester 113. Applications on federated software server 102 may use at least one standard SQL, XML or Web communication interface 114 connecting the client 100 to at least one remote server 120 via a network communication line 118, to obtain access to databases of multiple data sources such as a database server, DBMS 122, and data storage devices 124, 126, each of which may be a DB2 or non-DB2 source, and may reside on different systems and may store data in different formats. Remote server 120 has its own processor 123, communication interface 127 and memory 125.

Processor 123 is connected to one or more electronic data storage devices 124, 126, such as disk drives, that store one or more relational databases. They may comprise, for example, optical disk drives, magnetic tapes and/or semiconductor memory. Each storage device permits receipt of a program storage device, such as a magnetic media diskette, magnetic tape, optical disk, semiconductor memory and other machine-readable storage device, and allows for method program steps recorded on the program storage device to be read and transferred into the computer memory. The recorded program instructions may include the code for the method embodiments of the present invention. Alternatively, the program steps can be received into the operating memory 125 from a computer over the network.

Operators of the client terminal 108 use a standard operator terminal interface (not shown), to transmit electrical signals to and from the client 100, that represent commands for performing various tasks, such as search and retrieval functions, termed queries, against the database stored on the electronic data storage device 124, 126. In the present invention, these queries conform to the Structured Query Language (SQL) standard, and invoke functions performed by a DataBase Management System (DBMS) 122, such as a Relational DataBase Management System (RDBMS) software. In the preferred embodiments of the present invention, the RDBMS software is the DB2 product, offered by IBM for the AS400 or z/OS operating systems, the Microsoft Windows operating systems, or any of the UNIX-based operating systems supported by the DB2. Those skilled in the art will recognize, however, that the present invention has application to any RDBMS software that uses SQL, and may similarly be applied to non-SQL queries.

FIG. 1 further illustrates a software environment of the present invention which enables the preferred embodiments of the present invention. For that purpose the remote server 120 of the system shown in FIG. 1 includes a dynamic data formatting utility 130 which incorporates preferred methods of the present invention for dynamically changing the format of generalized byte strings, obtained from databases of at least one data source, such as DBMS 122, and data storage devices 124, 126, during transmittal of generalized byte strings across the network communication line 118, for efficient retrieval of all ranges of data values defined in XML or LOB format and all datatypes that have the pattern of the column definition being much bigger than the actual size. Dynamic data formatting utility 130 communicates with the dynamic data formatting utility requester 113 to send and receive requests and replies.

The preferred embodiments of the present invention preferably use, across the network communication line 118 and for access to data sources on storage devices 124, 126, a Distributed Relational Database Architecture (DRDA) protocol, using the Structured Query Language (SQL) interface, and data are formatted and transported according to the DRDA communication protocol rules and loaded directly into the client 100. The invention preferably uses standard SQL commands, which may be complex SQL commands. It allows use of union and join function, used to join together data from multiple data sources. However, the present invention is not limited to federated environment and it is applicable to a simple system where the data for formatting all reside in only one database stored in the data storage device 124 of the remote server 120.

Because the data often reside in multiple data sources and are possibly stored in different formats, the preferred method uses Distributed Relational Database Architecture (DRDA) internals. Transfer of data from multiple data sources, possibly stored in different formats, is preferably accomplished using a conventional technology. Thus, developers can transfer data values from a query result set where record attributes may span multiple data sources. Furthermore, they can access any or all of these attributes within a single transaction. Since the present invention may be supported by a variety of leading information technology vendors, this offers many potential business benefits, such as increased portability and high degrees of code reuse, without placing any programming burden on application developers.

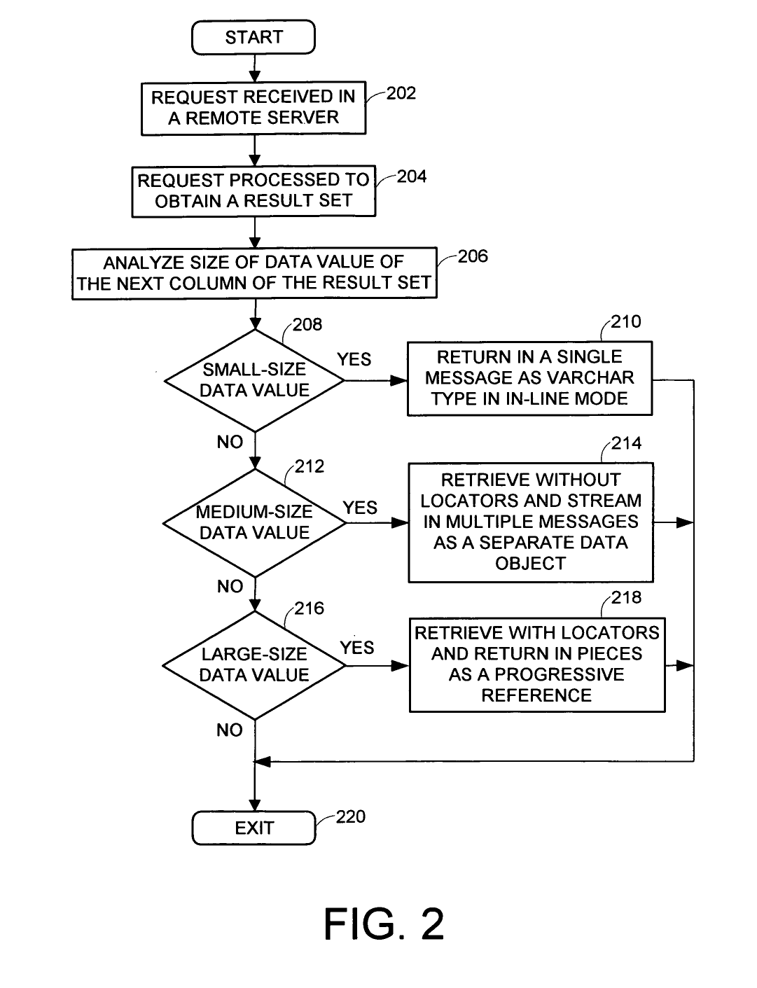

FIG. 2 illustrates a flowchart of an exemplary method for dynamic data formatting of character strings declared as large objects (LOB), XML data and all datatypes that have the pattern of the column definition being much bigger than the actual size, according to the preferred embodiments of the present invention, implemented in the dynamic data formatting utility 130 illustrated in FIG. 1. The preferred embodiments of the present invention utilize a new concept of Dynamic Data Format which allows any generalized byte string data in a result set, such as LOB or XML data, to be returned in a representation that is determined by DBMS 122 at the time when the data is retrieved, based on actual data value size. The method provides DBMS 122 with the ability not to flow such data separate from the rest of the query data when it is inefficient or impractical to do so. Although the present invention is described in reference to LOB data, it equally applies to XML data and all datatypes that have the pattern of the column definition being much bigger than the actual size

Thus, the preferred embodiments of the present invention are capable of efficient retrieval of small-size LOB data, where the performance is as close to that of retrieving a varchar, of medium-sized LOB data, where it is more efficient not to use a locator but to get all the LOB data at once and caching them on the client 100, and for large-size LOB data, where using a locator is preferred, as the entire LOB does not need to be materialized all at once.

What represents a small, medium and large size is defined as a threshold and provided to DBMS 122 as a default size value, via dynamic data formatting utility requester 113. Thus, small-size LOB data may be defined as having the data value below or equal to 32 KB, medium-sized LOB data may be defined as having the data value between 32767 and 1MB, and large-size LOB data may be defined as having the data value between 1 MB and 2 GB or more.

According to the preferred method embodiment of the present invention, in step 202 of FIG. 2, a single request, such as a SQL query, is received from application 112 in DBMS 122 of the remote server 120. The present invention provides the ability to dynamically change each data value format from a single request from application 112 to a remote server 120 separately, when the request returns multiple data values in a result set. All data values of the request have to be defined in the same, LOB or XML format and all datatypes that have the pattern of the column definition being much bigger than the actual size, and are thus of the same data type. Because the data type values can range from very small size of a few bytes to a very large size of many megabytes, the preferred method optimizes storage utilization and network efficiency by controlling how data values from the result set are returned, determined according the actual data value size.

DBMS 122 processes the query and obtains the result set in step 204. In step 206 DBMS analyses the data value of the next column of the result set. If it is determined in step 208 that it is a small-size data value, it is returned in step 210 in in-line mode, in a single network message, as would data of varchar type. If it is determined in step 212 that it is a medium-sized data value, in step 214 it. is retrieved without locators, and streamed in multiple network messages as a separate data object. On client 100, it is all at once cached in memory 105. If it is determined in step 216 that it is a large-size data value, it is retrieved, in step 218, using a more efficient data retrieval mechanism with locators and returned in pieces as a progressive reference, where each piece of data value is separately transferred under client's control when needed, thus eliminating the need for the client 100 to buffer large amount of data, as the entire data value does not need to be materialized all at once. Program exits in step 220.

Because the exact data format representation is determined by DBMS 122, at the time when the specific data is retrieved, several modes of representation are supported by DBMS 122 and application 112. Mode 1 is used for representation of small-size data values, Mode 2 is used for representation of medium-size data values and Mode 3 is used for representation of large-size data values. In Mode 1, data values are returned in-line with the rest of the query data, in Mode 2 data values are returned in a separate data object following the query data and in Mode 3 data values are returned as a progressive reference.

A progressive reference of Mode 3 is a data reference representing the data from the corresponding column in the result set. The life of a progressive reference is tied to its originating cursor, and if the cursor is closed/freed implicitly or explicitly, the progressive reference will also be freed, which is one of he benefits of the present invention. The name “progressive” indicates that the data returned through such a reference are always progressive or sequential, and a new mechanism is provided to retrieve the next piece of data associated with a given progressive reference.

Traditionally, a LOB in a result set is flown from DBMS 122 in a format requested specifically by the application 112 requester, either as a LOB value or a LOB locator. Using Dynamic Data Format of the present invention, DBMS 122 determines the most efficient format for returning the particular LOB data when it is retrieved, based on its actual size, unless overridden by the application 112 requester. With no override specified, DBMS 122 can return or flow small LOB data in Mode 1, medium LOB data in Mode 2 and large LOB data in Mode 3. Dynamic Data Format allows DBMS 122 to determine the mode in which to return LOB or XML data and all datatypes that have the pattern of the column definition being much bigger than the actual size, based on the size of the data value and, additionally, on a set of thresholds. The requester may specify thresholds for the maximum size of Mode 1 data, which may be 32 K, and the maximum size of Mode 2 data, which may be 1 MB. All data exceeding in size the Mode 2 threshold will be returned via Mode 3. If not specified by the requester, DBMS 122 employs default thresholds. Data that does not exceed the Mode 1 threshold will be returned in-line with the rest of the query data, achieving a significant performance benefit by eliminating subsequent trips across the network. Data that exceeds the Mode 1 threshold but not the Mode 2 threshold will be returned in a separate data object following the query data, but in the same response from DBMS 122. Data exceeding the Mode 2 threshold will result in a progressive reference being returned to the requester. Thresholds settable by the application 112 requester allow for performance tuning by the client 100, and elimination of certain modes where desirable. For example, if the Mode 1 and Mode 2 thresholds are set equal, no data will be sent in Mode 2.

In order to enhance the sequential retrieval of large data, a new data request mechanism is introduced in the preferred embodiments of present invention, along with the progressive reference, which allows the application 112 requester to specify a desired piece length for the progressive reference. Thus, DBMS 122 can manage the progression of the reference through the data value size and return the subsequent piece of the data of the requested length. This method provides an optimization over the conventional method which uses the SQL SUBSTR statement with the SQL LOB locator to achieve the same purpose. However, the preferred aspects of the present invention avoid any unnecessary blank padding for the LOB data value. Further, locators only remain active for an amount of time necessary, which prevents consuming valuable server resources and possibly reaching the limit on the total number of active locators. Thus, by enforcing sequential access for LOB, XML data and all datatypes that have the pattern of the column definition being much bigger than the actual size, retrieved using Dynamic Data Format, the problems described above with respect to SUBSTR processing are avoided. Furthermore, resource utilization is improved since resources associated with progressive references are freed at the cursor scope, in remote server 120, and not at the transaction scope, in client 100. Another aspect of the present invention provides a mechanism by which progressive references may be freed upon any cursor movement.

The preferred embodiments of the present invention for dynamic data formatting during transmittal of XML and LOB data across the network have been implemented in DB2 for Z/OS V9 and Java Universal Driver. They are especially applicable for network computing and distributed database systems, high speed data transmission and networking, gigabyte Ethernet, data coding/encoding and data assembly and formatting techniques. They are applicable to any product that supports JDBC and CLI APIs.

The foregoing description of the preferred embodiments of the present invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for dynamic data formatting during transmittal of generalized byte string data across a computer network connecting a client and a remote server, comprising:
(a) in the remote server, dynamically changing format of each string data value from a query result set separately, according to actual size of the string data value; and
(b) returning each string data value to the client.

2. The method according to claim 1, wherein the dynamic data formatting is performed by a database server in the remote server, at the time of data retrieval caused by receipt of a single request to the remote server which returns multiple data values in the result set, by controlling a return mode and representation of each data value from the result set.

3. The method according to claim 2, wherein the mode and representation is defined by a Dynamic Data Format mechanism to enforce sequential access for retrieved data.

4. The method according to claim 1, wherein a small-size data value is returned in a single network return message as varchar type, in-line with the rest of the query data.

5. The method according to claim 1, wherein a medium-sized data value is retrieved without locators and streamed in multiple return network messages in a separate data object following the query data and in the same response.

6. The method according to claim 1, wherein a large-size data value is retrieved using locators and returned as a progressive reference in pieces of specified size, where each piece of data value is separately transferred under client's control when needed, thus eliminating the need to buffer large amount of data.

7. The method according to claim 1, wherein the generalized byte string data are sequentially retrieved by a progressive reference data request mechanism to return data in pieces, according to a specified piece length, wherein the progressive reference manages the progression of return of each piece of data of the requested length and frees resources associated with the progressive references with the release of the progressive reference.

8. The method according to claim 1, wherein the generalized byte string data are selected from the group consisting of large object (LOB), XML data, small character strings, serialized Java objects, XML documents and all datatypes that have the pattern of definition being much bigger than the actual size, and wherein a threshold, determining whether the actual size of the string data value is deemed small, medium or large, is provided to the remote server by the client for performance tuning.

9. The method according to claim 1, wherein the remote server has access to multiple data sources, physically distributed and disparate DBMSs, residing on different hardware systems and possibly storing data in a different format.

10. The method according to claim 1, wherein the computer network connecting the client and the remote server uses a Distributed Relational Database Architecture (DRDA) protocol.

11. A system for dynamic data formatting during transmittal of generalized byte string data across a computer network connecting a client and a remote server, comprising:
means in the remote server for dynamically changing format of each string data value from a query result set separately, according to actual size of the string data value; and
means for returning each string data value to the client.

12. The system according to claim 11, wherein the dynamic data formatting is performed by a database server in the remote server, at the time of data retrieval caused by receipt of a single request to the remote server which returns multiple data values in the result set, by controlling a return mode and representation of each data value from the result set.

13. The system according to claim 12, wherein the mode and representation is defined by a Dynamic Data Format mechanism to enforce sequential access for retrieved data.

14. The system according to claim 11, wherein a small-size data value is returned in a single network return message as varchar type, in-line with the rest of the query data.

15. The system according to claim 11, wherein a medium-sized data value is retrieved without locators, and streamed in multiple return network messages in a separate data object following the query data and in the same response.

16. The system according to claim 11, wherein a large-size data value is retrieved using locators and returned as a progressive reference in pieces of specified size, where each piece of data value is separately transferred under client's control when needed, thus eliminating the need to buffer large amount of data.

17. The system according to claim 11, wherein the generalized byte string data are sequentially retrieved by a progressive reference data request mechanism to return data in pieces, according to a specified piece length, wherein the progressive reference manages the progression of return of each piece of data of the requested length and frees resources associated with the progressive references with the release of the progressive reference.

18. The system according to claim 11, wherein the generalized byte string data are selected from the group consisting of large object (LOB), XML data, small character strings, serialized Java objects, XM:L documents and all datatypes that have the pattern of definition being much bigger than the actual size, and wherein a threshold, determining whether the actual size of the string data value is deemed small, medium or large, is provided to the remote server by the client for performance tuning.

19. The system according to claim 11, wherein the remote server has access to multiple data sources, physically distributed and disparate DBMSs, residing on different hardware systems and possibly storing data in a different format.

20. The system according to claim 11, wherein the computer network connecting the client and the remote server uses a Distributed Relational Database Architecture (DRDA) protocol.

21. A program storage device readable by a computer tangibly embodying a program of instructions executable by the computer to perform method steps for dynamic data formatting during transmittal of generalized byte string data across a computer network connecting a client and a remote server, comprising:
(c) in the remote server, dynamically changing format of each string data value from a query result set separately, according to actual size of the string data value; and
(d) returning each string data value to the client.

22. The method according to claim 21, wherein the dynamic data formatting is performed by a database server in the remote server, at the time of data retrieval caused by receipt of a single request to the remote server which returns multiple data values in the result set, by controlling a return mode and representation of each data value from the result set.

23. The method according to claim 22, wherein the mode and representation is defined by a Dynamic Data Format mechanism to enforce sequential access for retrieved data.

24. The method according to claim 21, wherein a small-size data value is returned in a single network return message as varchar type, in-line with the rest of the query data.

25. The method according to claim 21, wherein a medium-sized data value is retrieved without locators and streamed in multiple return network messages in a separate data object following the query data and in the same response.

26. The method according to claim 21, wherein a large-size data value is retrieved using locators and returned as a progressive reference in pieces of specified size, where each piece of data value is separately transferred under client's control when needed, thus eliminating the need to buffer large amount of data.

27. The method according to claim 21, wherein the generalized byte string data are sequentially retrieved by a progressive reference data request mechanism to return data in pieces, according to a specified piece length, wherein the progressive reference manages the progression of return of each piece of data of the requested length and frees resources associated with the progressive references with the release of the progressive reference.

28. The method according to claim 21, wherein the generalized byte string data are selected from the group consisting of large object (LOB), XML data, small character strings, serialized Java objects, XML documents and all datatypes that have the pattern of definition being much bigger than the actual size, and wherein a threshold, determining whether the actual size of the string data value is deemed small, medium or large, is provided to the remote server by the client for performance tuning.

29. The method according to claim 21, wherein the remote server has access to multiple data sources, physically distributed and disparate DBMSs, residing on different hardware systems and possibly storing data in a different format.

30. The method according to claim 21, wherein the computer network connecting the client and the remote server uses a Distributed Relational Database Architecture (DRDA) protocol.
